(19) United States
(12) Patent Application Publication
(10) Pub. No.: US 2025/0219501 A1
(43) Pub. Date: Jul. 3, 2025

(54) DEVICE FOR THE STORING AND REUSE OF ENERGY

(71) Applicant: Michelangelo SASSANELLI, Longare (VI) (IT)

(72) Inventor: Michelangelo SASSANELLI, Longare (VI) (IT)

(21) Appl. No.: 18/841,650

(22) PCT Filed: Feb. 27, 2023
(86) PCT No.: PCT/IB2023/051793

§ 371 Date: Aug. 26, 2024

(30) Foreign Application Priority Data
Feb. 28, 2022 (IT) 102022000003737
Feb. 27, 2023 (IT) 102023000003285

(51) Int. Cl. H02K 7/02; H02K 7/00; H02K 11/30

(52) U.S. Cl. CPC H02K 7/025; H02K 7/003; H02K 11/30

(57) ABSTRACT

Device for the storing and reuse of energy comprising at least one support structure (2), at least one first flywheel (3; 103) rotatably constrained to the support structure (2) and at least partially enclosed in its inside, at least one first motor (5) and also comprising at least one processing and control logic unit (9) configured to control at least the operation of the first motor (5). This device also comprises at least a second flywheel (4; 104) rotatably constrained to the support structure (2) and at least partially enclosed in its inside and at least one second motor (6) operatively connected to the second flywheel (4; 104). Furthermore, the processing and control logic unit (9) is operatively connected to the second motor (6) to control its operation independently with respect to the control of the first motor (5).

### DESCRIPTION

### Field of application

The present invention is applicable to the electrical sector and its subject-matter is in particular the storage, conversion, generation and distribution of energy.

More in detail, the present invention refers to a device for the storing and reuse of energy.

### State of the art

With the continuous increase in energy demand, various problems have emerged related to the development of an efficient energy generation and distribution system.

In particular, it is becoming increasingly essential to have adequate energy storage systems (ESS). These can be considered key elements that make it possible to increase the value of the energy produced, improving its quality and the availability over time. In fact, they are often defined as buffers that decouple electrical energy generation and consumption.

There are many systems for storing electrical energy, among which we remind the conversion into chemical energy (chemical batteries), potential (water pumping) and kinetics (flywheels). The latter can be carried out by systems based on flywheel batteries (called FES or Flywheel energy storage systems), which are systems that store kinetic energy thanks to the inertia of rotation of a flywheel.

In other words, the flywheel batteries store energy by increasing the speed of a flywheel magnetically coupled to an electric motor. In particular, generally, the flywheel batteries are composed of a flywheel, a motor/generator and control electronics for connection to an external power grid.

In practice, a flywheel battery absorbs energy from an electrical source to charge, stores it in the form of rotational kinetic energy and, when needed, supplies it to the load in the form required by the load itself.

However, the factor that most restricts the spread of flywheel batteries is their high initial cost compared to other technologies. However, it should be reminded that, without requiring maintenance, their price becomes very competitive, especially if they are used for applications that quickly degrade the competitors' chemical batteries (in particular in the case of frequent charge/discharge cycles). However, efficiency tends to drop if the cycles of use are not continuous and are therefore more spaced apart over time. In this case, in fact, the high rate of self-discharge negatively affects the total efficiency in the long run.

Although the rate of self-discharge is limited by some technical solutions, such as vacuum operation and the use of magnetic bearings, it remains one of the highest among the various energy storage systems.

In addition to this, an undesirable consequence that derives from the rotation of the flywheel is the high gyroscopic effect that is manifested when there is a tendency to rotate its axis of rotation. This turns out to be very inconvenient when the battery is installed on a moving vehicle, such as a car or satellite.

Furthermore, typically, a flywheel battery storage system is more complex to design and realize than one based on chemical batteries, also because it is often designed specifically for a specific application or user. Therefore, the design and manufacture of the flywheel and of the casing require great precision and careful post-production analysis to ensure sufficient safety standards.

### PRESENTATION OF THE INVENTION

Aim of the present invention is to at least partially overcome the drawbacks highlighted above.

In particular, the aim of the present invention is to provide a device for the storing and reuse of energy that is not of the electrochemical type, being however integrable and/or connectable to other storage systems.

Another aim of the present invention is to provide a device for the storing and reuse of energy which allows it to be used in a safe and reliable manner.

A further aim of the present invention is to provide a device for the storing and reuse of energy that allows high energy to be stored without affecting its stability.

Another aim of the present invention is to provide a compact device.

Another aim of the present invention is to provide a device for the storing and reuse of energy that allows to control the gyroscopic effect.

A further aim of the present invention is to provide a device for the storing and reuse of energy which allows to limit the self-discharge effect with respect to the devices of the prior art.

The aforementioned purposes, as well as others that will appear more clearly hereinafter, are achieved by a device for the storing and reuse of energy in accordance with the claims that follow which are to be considered an integral part of this patent.

In particular, it comprises at least one support structure, at least one first flywheel and at least one first motor.

The first flywheel, which is enclosed at least partially inside the support structure, is rotatably constrained to the support structure itself so as to rotate around at least a first axis of rotation.

As far as the first motor is concerned, it is operatively connected to the first flywheel and is configured to drag it into rotation, that is rotate it, in a first direction of rotation.

The device also comprises at least one processing and control logic unit operatively connected to the first motor and configured to control at least its operation.

According to another aspect of the invention, the device also comprises at least a second flywheel, also rotatably constrained to the support structure so as to rotate around at least one second axis of rotation, and also at least partially enclosed inside the structure itself. In particular, the second axis of rotation is parallel to the first axis of rotation.

Furthermore, the device of the invention comprises at least a second motor operatively connected to the second flywheel and configured to drag it into rotation, that is rotate it, in a second direction of rotation.

According to a further aspect of the invention, the processing and control logic unit is also operatively connected to the second motor and is configured to control its operation independently with respect to the control of the first motor.

Advantageously, the device of the invention is of the flywheel type and is safe, reliable and integrable and/or connectable to other storage systems.

Still advantageously, the device for the storing and reuse of energy allows high energy to be stored without affecting the stability of the device itself.

Furthermore, the device of the invention has small dimensions, being still advantageously compact.

In addition to this, still advantageously, the device of the invention allows to control the gyroscopic effects caused by the rotation of the flywheels.

### BRIEF DESCRIPTION OF THE DRAWINGS

Further characteristics and advantages of the invention will become more evident in the light of the detailed description of a preferred, but not exclusive, embodiment of a device for the storing and reuse of energy according to the invention, illustrated by way of non-limiting example with the aid of the attached tables of drawings in which:

FIG. 1 represents a schematic view of a device according to the invention;

FIG. 2 represents a longitudinal sectional view of the device according to the invention;

FIG. 3 represents a schematic view of a different embodiment of the device according to the invention.

### DETAILED DESCRIPTION OF SOME PREFERRED EMBODIMENTS

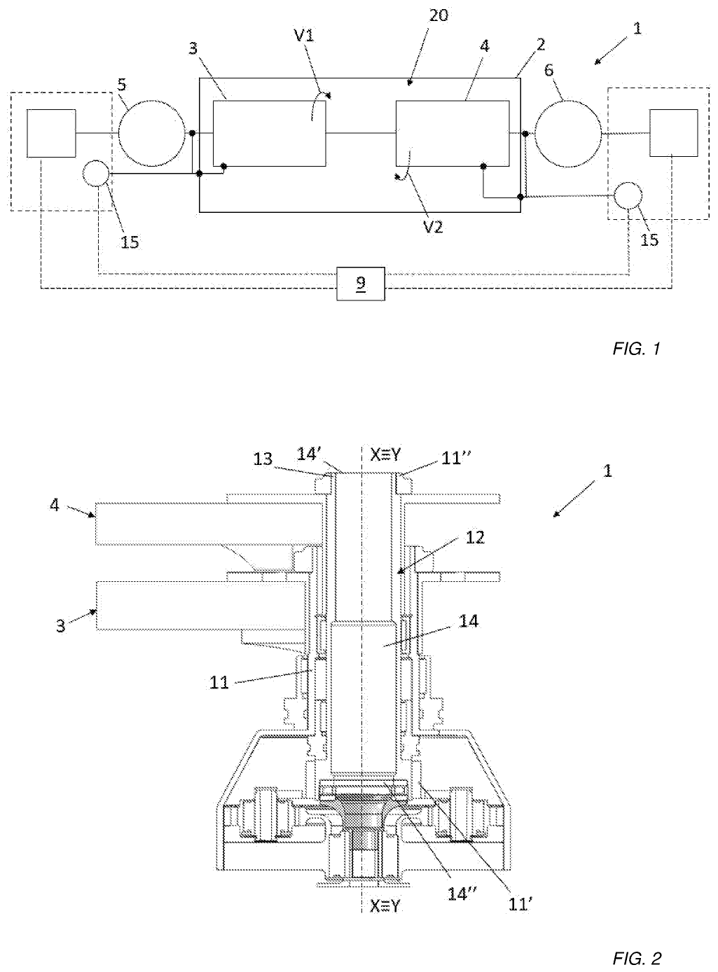

With reference to the figures cited, in particular to the FIGS. 1 and 2, a device for the storing and reuse of energy 1 according to the invention is described. In particular, it comprises a support structure 2, a first flywheel 3 and a first motor 5.

The first flywheel 3 is rotatably constrained to the support structure 2 so that it can rotate around a first axis of rotation X.

Furthermore, the first flywheel 3 is enclosed, at least partially, inside the support structure 2, in fact, such a structure 2 comprises a compartment 20 configured to house in its inside parts of the device 1 of the invention.

As regards the first motor 5, it is operatively connected to the first flywheel 3 and configured to drag it into rotation according to a first direction of rotation V1.

According to another aspect of the invention, the device 1 also comprises a processing and control logic unit 9, which is operatively connected to the first motor 5 and is configured to control its operation.

According to a further aspect of the invention, the device for the storing and reuse of energy 1 also comprises a second flywheel 4 also rotatably constrained to the support structure 2 so as to rotate around a second axis of rotation Y. In addition, the second flywheel is also enclosed, at least partially, inside the support structure 3.

In particular, according to the embodiment of the invention described, both flywheels 3 and 4 are enclosed inside the compartment 20.

Obviously, this aspect should not be considered as limiting for different embodiment variants of the invention where, for example, a portion of one or more flywheels is not enclosed inside the support structure.

Furthermore, also the arrangement of the motors and of the processing and control logic unit is not to be considered limiting for different embodiment variants of the invention where, for example, they are inside or outside the support structure.

In addition to this, the second flywheel 4 is arranged so that the second axis of rotation Y is parallel to the first axis of rotation X. Parallel is understood as it can be inferred from the known dictionaries, that is, straight lines that retain a constant distance at each point, a definition that therefore also comprises coincident parallel lines.

According to another aspect of the invention, the device 1 comprises a second motor 6 operatively connected to the second flywheel 4 and configured to drag it into rotation in a second direction of rotation V2.

Furthermore, the logic unit 9 is also operatively connected to the second motor 6 and is configured to control its operation independently with respect to the first motor 5.

In other words, the device for the storing and reuse of energy 1 comprises a support structure 2 which encloses a first and a second flywheel 3 and 4, which are respectively connected to a first and a second motor 5 and 6. Furthermore, the device 1 also comprises a processing and control logic unit 9 configured to control the operation of the two motors 5 and 6 independently of each other, which motors 5 and 6 are shaped to drag into rotation the respective flywheels 3 and 4 according to parallel axes of rotation X and Y.

Thus, advantageously, the device 1 of the invention allows energy to be stored, without resorting to the use of chemicals, in a safe, reliable and stable manner.

Furthermore, the device 1 of the invention encloses the two flywheels 3 and 4 inside the same support structure 2. This allows, still advantageously, to limit the dimensions of the device 1 itself.

Then, being the first and second flywheels 3 and 4 enclosed inside the same support structure 2 and moved independently of each other, the device 1 of the invention allows to control the gyroscopic effect.

In fact, through the logic unit 9 it is possible to control the speeds and the directions V1 and V2 of rotation of the two independent flywheels 3 and 4, which can counterbalance and/or control or cancel the imbalance of a system subjected to rotation by simply inducing a counter-rotation of one of the flywheels 3 and 4 cancelling or controlling the gyroscopic momentum. Obviously, the speed and the direction of rotation of the flywheels are not to be understood as limiting for different embodiment variants of the invention.

In addition to this, still advantageously, the independent control of the first and second flywheels 3 and 4 allows the device 1 of the invention to perform two functions simultaneously.

Moreover, the device 1 is able to work even in the event of malfunction of one of the two flywheels 3 and 4 as the operation of one is not affected by the inconveniences that have occurred to the other.

Still advantageously, the device 1 according to the invention can for example be configured to recover and use energy from the working cycle of industrial machinery (for example progressive presses or mining systems).

Furthermore, the device 1 according to the invention may for example be configured to store and reuse energy from electrical cogeneration systems, for example solar and/or photovoltaic and/or wind panels.

Still advantageously, the device 1 according to the invention can for example be configured to recover energy from the braking of a vehicle and/or to assist sudden accelerations of the vehicle itself.

Of course, the shape of the flywheels is not to be considered as limiting for different embodiment variants of the invention where, for example, the flywheels are perforated discoidal or toroidal or the like.

Furthermore, the materials with which the flywheels are made should also not be considered as limiting for different embodiment variants of the invention where, for example, they are made of metallic or polymeric or composite material, or in the case where the composite material that composes the first and/or second flywheel comprises a class IM9 carbon fibre, in which the fibres have a specific mass per unit with length equal to about 0.335 g/m and a density equal to about 1.80 g/cm³ (the composite material comprising the aforementioned carbon fibres and epoxy resin has a density equal to about 1620 kg/m³).

In hindsight, the control of the flywheels 3 and 4 allows to adjust the rotation speed regardless of their shape or material. Moreover, the two flywheels, according to different embodiment variants not represented in the figures, are made with shapes and materials different from each other.

Still advantageously, the possibility of using the device 1 of the invention allows to obtain a high “continuous” impulsive power i.e. without temporal discontinuities for long periods of time simply by making the discharge period of the first flywheel 3 coincide with the charge period of the second flywheel 4 (temporal translation) thus obtaining an alternating periodic charge/discharge cycle between the two flywheels 3 and 4 which ensures a continuous pulsive cyclic power without temporal discontinuities.

According to another aspect of the invention, the device 1 also comprises a first rotation shaft 11, on which the first motor 5, is operatively coupled, and a second rotation shaft 14, on which the second motor 6 is operatively coupled. Such rotation shafts 11 and 14 are free to rotate independently of each other.

According to the embodiment of the invention being described, the flywheels 3 and 4 are arranged so that the first axis of rotation X is coaxial with the second axis of rotation Y. Thus, the axes of rotation X and Y are coincident parallels.

Advantageously, the rotation of the flywheels 3 and 4 around coaxial axes of rotation X and Y allows the improvement of the control over the gyroscopic effect.

Still according to the embodiment of the invention being described, the first rotation shaft 11 is hollow so as to define in its inside a housing volume 12 shaped to receive in its inside the second rotation shaft 14.

In other words, the second shaft 14 is at least partially housed within the hollow first shaft 11. Thus, the first flywheel 3 is mechanically mounted on the first rotation shaft 11, which is internally hollow so as to define in its inside a housing volume 12, and extends between a first end 11′ keyed to the first motor 5 and a second end 11″ in which a through opening 13 is made.

Furthermore, the second flywheel 4 is mechanically mounted on a second rotation shaft 14 at least partially housed within the housing volume 12 of the first rotation shaft 11 and extends between a third end 14′ keyed to the second motor 6 and a fourth end 14″ housed within the housing volume 12.

In particular, the second shaft 14 has a substantially cylindrical shape and is substantially fitted to measure within the housing volume 12.

Advantageously, this arrangement of the device 1 according to the invention is extremely compact and mechanically stable.

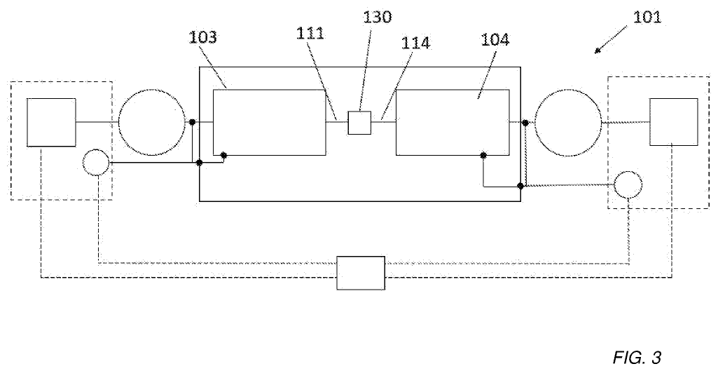

According to an embodiment variant, represented in FIG. 3, the rotation shafts 111 and 114 are aligned and typically, but not necessarily, they are operatively interposed by a joint 130 configured to decouple their rotations.

Advantageously, the aligned arrangement of the shafts 111 and 114 and, consequently, of the flywheels 103 and 104 still allows to achieve the advantages listed above regarding the control of the gyroscopic effect.

Furthermore, the joint 130 is typically, but not necessarily, supported by one or more arms which allow it to be placed in the suitable position without separating the environment from the two flywheels 103 and 104.

According to a further aspect of the invention, the device 1 also comprises a first system of electrical circuits, not represented in the figures, operatively connected to the first and second flywheels 3 and 4, configured to allow the exchange of energy between one flywheel and another.

Advantageously, this connection between the flywheels 3 and 4 allows one of the flywheels to be used so that it behaves as if it were a secondary “self-supporting” circuit to the main circuit, i.e. to the main flywheel or to the one used with less continuity (whose cycles of use depending on the specific application are more spaced apart over time) or by functional symmetric exchange between the two flywheels.

Functional exchange between the two flywheels 3 and 4 means the ability and/or possibility of the device 1 of the invention to be able to exchange the specific functionalities between the two flywheels 3 and 4. For example, suppose that the first flywheel 3 is subject to intense cycles of use over time depending on its specific application (e.g. reactive power support) and, the second flywheel 4 instead is subject to fewer cycles of use over time also depending on its specific application (e.g. support for high impulsive powers) it is naturally evident that the second flywheel 4 would be more subject to the phenomenon of self-discharge. Therefore, a functional symmetrical exchange between the flywheels 3 and 4 is possible in order to reverse their functionalities.

Functional interchangeability effectively introduces a symmetrical partitioning of the self-discharge rate between the flywheels 3 and 4. The constancy of the partition rate can in fact be interpreted as an index of wear of the components.

In fact, let's imagine of a flywheel subject to high rates of self-discharge, de facto a flywheel used with less continuity and whose cycles of use, depending of course on the specific application, are more spaced apart over time with the consequent lower wear of the components, and instead let's imagine of a flywheel that has low rates of self-discharge and subject to intense cyclical continuity of use, depending of course on the specific application, cycles that are therefore considerably closer over time, with greater wear of the components. This asymmetry introduced by the self-discharge rate effect can be considerably controlled and/or reduced by the functional exchange thus preserving the functional integrity of the components of the system (the rate of wear is therefore a function of the self-discharge rate) or by “self-support”, in which case a so-called secondary flywheel will provide functional support “supplying energy” to a first flywheel resulting in a partition of the self-discharge rate.

According to another aspect of the invention, the device 1 also comprises a first sensor 15 operatively connected to the processing and control logic unit 9 and shaped to detect the angular momentum of the first flywheel 3 and/or of the second flywheel 4.

According to a further aspect of the invention, the device 1 also comprises a second sensor, not represented in the figures, operatively connected to the processing and control logic unit 9 and shaped to detect the imbalance of the first rotation shaft 11 and/or of said at least one second rotation shaft 14.

Typically, but not necessarily, the second sensor comprises a displacement sensor and controls a magnetic bearing, for example: permanent magnet bearings (called PMB), superconducting magnetic bearings (called SMB) and/or active magnetic bearings (called AMB).

Obviously, the number of first and second sensors must not be considered limiting for different embodiments of the invention where, for example, there is only one sensor or there are one or more sensors operatively connected to each motor.

According to another aspect, the device 1 of the invention also comprises a second system of electrical circuits, also not represented in the figures, configured to connect the device 1 itself to an external power grid.

In addition to this, according to different embodiment variants of the invention, not represented in the figures, the device also comprises one or more inverters which enable the motors to be powered with variable electrical quantities, in particular with supply voltage and/or current having an amplitude and/or variable frequency.

According to another aspect of the invention, the compartment 20 is an empty chamber.

The device 1 of the invention can be used in the cases reported below by way of example only, but not in a limiting manner.

In particular, the device 1 according to the invention can be used in an industrial process for mining that employs high power machines and that often have very high absorption peaks or characterized by irregular consumption.

In this process, for an optimal operation of the (internal) industrial smart grids and of the machinery, an appropriate reactive power support and an adequate support for high impulsive powers are required, which by acting simultaneously on the smart grid and machinery allow to reach the optimal of extraction process. In this case, the reactive power support carried out on the industrial smart grid can be implemented with at least one device 1 according to the invention which allows high scalability and the possibility of decentralizing this type of system. It is thus possible to compensate for the reactive power in a targeted way, without overloading the main transmission lines.

This translates into considerable savings on the costs of construction and expansion of the main and secondary industrial distribution lines.

Suitably, a device 1, even small/medium-sized, located in the critical areas of the grid is able to increase the potential of a smart grid already present in the industry. The device 1 according to the invention in fact allows a much more effective compensation of the reactive power than traditional capacitor-based systems. In particular, it is possible to obtain a nearly unitary power factor, by adapting the amount of reactive power absorbed/supplied according to the instantaneous conditions of the grid.

The use of the devices 1 according to the invention, for the correction of the power factor of industrial machinery, allows end users to avoid the additional costs charged by electricity supply companies for reactive power excess and, moreover, allows to have a better quality of power for particularly sensitive industrial and commercial applications.

Suitably, the device 1 according to the invention can be used for residential applications, in particular in association with power generation systems from renewable sources.

In fact, the device 1 according to the invention allows both to obtain a suitable power compensation system from renewable energy sources and an adequate reactive power support, and it also allows to obtain all the further functionalities previously mentioned, in particular with regard to the reduction/cancellation of the phenomena of self-discharge and of the gyroscopic effect.

Conveniently, furthermore, unlike the traditional solution with a single flywheel in which there are continuous charge/discharge cycles of the single flywheel, the device 1 according to the invention allows to obtain a high impulsive power and with a substantially “continuous” profile, i.e. without temporal discontinuities for long periods of time, and this is obtained simply by making the discharge period of the first flywheel coincide with the charge period of the second flywheel (time translation), thus obtaining an alternating periodic cycle of charge/discharge between the two flywheels which ensures a substantially continuous cyclic impulsive power without temporal discontinuity.

Suitably, the device 1 according to the invention is suitable for use in a plurality of applications such as: industrial machinery, construction field, sector of internal combustion, electric and/or hybrid vehicles, aerospace sector, biomedical sector, railway transport sector, and in any other sector in general where there is a need and/or possibility to reuse the stored energy.

In light of the foregoing, it is therefore understood that the device for the storing and reuse of energy of the invention achieves all of the intended purposes.

In particular, the device of the invention:
allows the storing of energy,
allows the frequency adjustment,
defines an energy reserve,
allows to give support to the reactive power,
allows it to be used as an uninterruptible power supply (UPS),
allows it to be used as power compensation from renewable energies,
ensures high impulse powers,
allows it to be used in a totally safe and reliable way;
is compact, as the two flywheels are constrained to corresponding shafts inserted into each other;
can be mass-produced and assembled quickly and efficiently;
can be easily installed in vehicles or machinery of a different type,
can be realized and assembled in a simple, fast and low-cost way,
is structurally and functionally completely reliable,
is improved and/or alternative to traditional solutions.

Furthermore, the device of the invention allows:
the control and/or cancellation and/or imbalance of the gyroscopic momentum,
the self-discharge control and reduction,
the gyroscopic self-stabilization control,
the functional symmetric exchangeability control,
the self-discharge control by functional symmetrical interchangeability,
at least one functionality being maintained in the event of a failure,
the operation of the motors in series and/or in parallel,
the control of high impulse power continues,
simultaneous or sequential execution of two applications.

The invention is susceptible to numerous modifications and variations, all falling within the appended claims. All details and phases may be replaced by other technically equivalent elements, and the materials may be different depending on the needs, without departing from the scope of protection of the invention defined by the attached claims.

1. Device for the storing and reuse of energy comprising:
at least one support structure;
at least one first flywheel rotatably constrained to said at least one support structure so as to rotate around at least one first axis of rotation, said at least one first flywheel being at least partially enclosed inside said at least one support structure;
at least one first motor operatively connected to said at least one first flywheel, said at least one first motor being configured to rotate said at least one first flywheel in a first direction of rotation;
at least one processing and control logic unit operatively connected to said at least one first motor, said at least one processing and control logic unit being configured to control at least the operation of said at least one first motor,
said device for the storing and reuse of energy comprising:
at least one second flywheel rotatably constrained to said at least one support structure so as to rotate around at least one second axis of rotation, said at least one second axis of rotation being parallel with respect to said at least one first axis of rotation, said at least a second flywheel being at least partially enclosed inside said at least one support structure;
at least one second motor operatively connected to said at least one second flywheel, said at least one second motor being configured to rotate said at least one second flywheel in a second direction of rotation,
said at least one processing and control logic unit being operatively connected to said at least one second motor, said at least one processing and control logic unit being configured to also control the operation of said at least one second motor independently with respect to the control of said at least one first motor.

2. Device according to claim 1, comprising:
at least one first rotation shaft on which said at least one first motor is operatively coupled;
at least one second rotation shaft on which said at least one second motor is operatively coupled,
said at least one first rotation shaft and said at least one second rotation shaft being free to rotate independently of each other.

3. Device according to claim 1, wherein said at least one first axis of rotation and said at least one second axis of rotation are coaxial.

4. Device according to claim 3, wherein said at least one first rotation shaft is at least partially hollow so as to define in its inside a housing volume shaped to receive at least partially said at least one second rotation shaft.

5. Device according to claim 3, wherein said at least one first rotation shaft and said at least one second rotation shaft are aligned.

6. Device according to claim 5, wherein said at least one first rotation shaft and said at least one second rotation shaft are operatively interposed by at least one joint configured to decouple the rotations of said at least one first rotation shaft and said at least one second rotation shaft.

7. Device according to claim 1, comprising a first system of electrical circuits that is operatively connected to at least said at least one first flywheel and to said at least one second flywheel, said circuit system being configured to allow the exchange of energy between said at least one first flywheel and said at least one second flywheel.

8. Device according to claim 1, comprising at least a first sensor operatively connected to said at least one processing and control logic unit and shaped to detect at least one angular momentum of said at least one first flywheel and/or of said at least one second flywheel.

9. Device according to claim 2, comprising at least a second sensor operatively connected to said at least one processing and control logic unit and shaped to detect at least the imbalance of said at least one first rotation shaft and/or of said at least one second rotation shaft.

10. Device according to claim 1, comprising a second system of electrical circuits that is configured to connect said device to at least one external power grid.
